(19) United States
(12) Patent Application Publication
(10) Pub. No.: US 2023/0402605 A1
(43) Pub. Date: Dec. 14, 2023

(54) ELECTROCHEMICAL BATTERY WITH A BIPOLAR ARCHITECTURE COMPRISING A MATERIAL COMMON TO ALL OF THE ELECTRODES AS ELECTRODE ACTIVE MATERIAL

(71) Applicants: COMMISSARIAT À L'ENERGIE ATOMIQUE ET AUX ÉNERGIES ALTERNATIVES, Paris (FR); SOLVAY, Bruxelles (BE)

(72) Inventors: Thibaut Gutel, Grenoble (FR); Jérémie Salomon, Grenoble (FR); Adrien Sartre, Grenoble (FR)

(21) Appl. No.: 18/251,357

(22) PCT Filed: Oct. 28, 2021
(86) PCT No.: PCT/FR2021/051901

§ 371 Date: May 1, 2023

(30) Foreign Application Priority Data
Nov. 2, 2020 (FR) 2011222

(51) Int. Cl. H01M 4/60; H01M 4/62; H01M 50/426

(52) U.S. Cl. CPC H01M 4/602; H01M 4/622; H01M 50/426; H01M 2004/029

(57) ABSTRACT

A battery with a bipolar architecture that comprises two terminal current collectors between which a stack of n electrochemical cells is arranged, n being an integer at least equal to 2, wherein: each electrochemical cell comprises a positive electrode, a negative electrode and an electrolytic component arranged between the positive electrode and the negative electrode; the n electrochemical cells are separated from one another by (n1) bipolar current collectors; and wherein the positive electrode and the negative electrode of each electrochemical cell comprise a common active material as active material, which is a redox-active organic compound comprising, respectively, at least one group able to capture electrons and at least one group able to donate electrons.

### DESCRIPTION OF INVENTION

### Technical Field

The invention relates to the field of electrochemical batteries with a bipolar architecture including, as an electrode active material, a material common to all electrodes.

The general field of the invention may be defined as that of energy storage devices, in particular, that of electrochemical batteries.

### PRIOR ART

Electrochemical batteries operate based on the principle of electrochemical cells capable of delivering an electric current thanks to the presence of a pair of electrodes (respectively, a positive electrode and a negative electrode) in each of them separated by an electrolyte, the electrodes comprising specific materials capable of reacting according to an oxidation-reduction reaction, whereby there is production of electrons at the origin of the electric current and production of ions which will circulate from one electrode to another through an electrolyte.

Amongst the batteries operating based on this principle, mention may be made of:
acid-lead batteries using lead and lead oxide PbO₂ as electrode active materials;
Ni-MH batteries using metal hydride and nickel oxyhydroxide as electrode active materials;
batteries using nickel or a nickel-based compound to make the active material of at least one of the electrodes, such as Ni-MH batteries using, in particular a metal hydride and nickel oxyhydroxide as electrode active materials; Ni—Cd batteries using cadmium and nickel oxyhydroxide as electrode active materials or nickel-zinc batteries using nickel hydroxide and zinc oxide as electrode active materials; and
batteries operating based on the principle of insertion-deinsertion of an alkaline or alkaline-earth element intervening at the electrodes (and more specifically, of the electrode active materials), batteries operating based on this principle and currently used being the batteries of the lithium-ion type using, entirely or partly, lithiated materials to make the electrode active materials.

For some years now, these Li-ion batteries have largely dethroned the above-mentioned other batteries thanks to the continuous improvement of the performances of Li-ion batteries in terms of energy density. Indeed, lithium-ion batteries allow obtaining mass and volume energy densities (which may be higher than 180 Wh·kg⁻¹) substantially higher than those of Ni-MH and Ni—Cd batteries (which may range from 50 to 100 Wh·kg⁻¹) and Acid-lead batteries (which may range from 30 to 35 Wh·kg⁻¹).

At present, the lithium-ion battery market is dominated by a so-called “monopolar” architecture, i.e. an architecture wherein a battery includes only one electrochemical cell which uses, for example, a positive electrode based on lithium cobalt oxide (LiCoO₂) and a negative electrode based on graphite, separated from each other by an electrolytic constituent (in general, a separator impregnated with a liquid electrolyte) which conducts lithium ions, the rated voltage of these batteries being in the range of 3.6 V.

Hence, with such an architecture, to obtain a high voltage, it is necessary to associate several single-cell batteries in series via external connections.

In contrast with this monopolar architecture, a new generation of batteries with a so-called bipolar architecture has been the subject of studies for several years.

Batteries with a bipolar architecture comprise, as illustrated in appended FIG. 1, two terminal current collector substrates 1, 3 and a stack of electrochemical cells (C₁, C₂, . . . , Cₙ) each comprising a positive electrode 5, a negative electrode 7 and a separator 9 interposed between the positive electrode and the negative electrode in the presence of a lithium ion conductive electrolyte, when the battery is a lithium-ion battery, in which stack the electrochemical cells are separated from each other by a current collector substrate, called bipolar current collector substrate 11, which is in the form of a sheet one face of which is in contact with the negative electrode of an electrochemical cell whereas the other face is in contact with the positive electrode of the adjacent electrochemical cell.

Thus, the bipolar architecture corresponds to a serial connection of several batteries by means of so-called bipolar current collector substrates, which allows dispensing with external connections, which are necessary for assembling monopolar batteries in series. Hence, it results in lighter systems than those resulting from a serial assembly of monopolar batteries, thereby increasing the energy density. In addition, depending on the number of cells making up the stack, the final voltage of the battery can be easily adjustable and can be very high, if desired.

Nevertheless, the provision of this type of architecture requires the preparation of biface electrode(s) from two distinct formulations and, in particular, a formulation for making the negative electrode over a first face of the current collector substrate of the biface electrode (this formulation conventionally comprising an negative electrode active material, such as graphite or Li₄Ti₅O₁₂) and a formulation for making the positive electrode over a second face opposite to the first face of the current collector substrate of the biface electrode (this formulation conventionally comprising a positive electrode active material, such as lamellar oxides or LiFePO₄) and thus the implementation of two distinct steps of ink preparation and deposition. The same applies to the terminal electrodes of the stack which require a distinct preparation, namely a preparation for the terminal positive electrode and a preparation for the terminal negative electrode.

Hence, to overcome these drawbacks, the inventors have set themselves the objective of providing new batteries with a bipolar architecture with a simple assembly which do not require the use of multiple formulations to make the electrodes and which also have the following advantages:
a lower manufacturing cost; and
an easier cell balancing.

### DISCLOSURE OF THE INVENTION

The authors of the present invention have succeeded to achieve the aforementioned objectives by implementing in batteries with a bipolar architecture an active material common to all of the electrodes making up the batteries.

Also, the batteries with bipolar architecture of the invention may thus be defined as being batteries with a bipolar architecture which comprise two terminal current collectors between which is arranged a stack of n electrochemical cells is disposed, n being an integer at least equal to 2, wherein:
each electrochemical cell comprises a positive electrode, a negative electrode and an electrolytic constituent disposed between the positive electrode and the negative electrode;
the n electrochemical cells are separated from each other by n−1 bipolar current collectors;
and which are characterised in that the positive electrode and the negative electrode of each electrochemical cell comprise, as an active material, a common active material, which is an organic redox compound comprising, respectively, at least one group capable of capturing electrons and at least one group capable of donating electrons.

Before getting into more detail in the description, we specify the following definitions.

By positive electrode, it should conventionally be understood, in the foregoing and next, the electrode that acts as a cathode, when the battery delivers current (i.e. when it is discharging) and which acts as an anode, when the battery is being charged.

By negative electrode, it should conventionally be understood, in the foregoing and next, the electrode that acts as an anode, when the battery delivers current (i.e. when it is discharging) and which acts as a cathode, when the battery is being charged.

By organic compound, it should conventionally be understood, a carbon chemistry compound, including carbon and hydrogen atoms and one or more heteroatom(s) selected from among oxygen, nitrogen, sulphur, phosphorus, these atoms and these heteroatoms being linked only by covalent bonds, this compound possibly being in the form of salts.

In the context of the invention, the use both at each positive electrode and at each negative electrode of the same redox compound, which is capable of ensuring, by the presence of at least one group capable of capturing electrons and at least one group capable of donating electrons, the role of an oxidant active material and of a reductant active material, allows achieving the following advantages:
decrease in the costs related to this simplification and also to the fact that one single redox compound has to be procured or produced; and
ease of manufacture thanks to the possibility of using one single formulation based on the same ingredients to manufacture the electrodes;
easier balancing of the cells, in the case where the two redox groups carried by the organic redox compound exchange the same number of electrons, thanks to the fact of being able to have identical electrode capacitances thanks to an identical grammage or, on the contrary, thanks to the fact of being able to adjust the capacitances of the two faces by modifying only the deposit thickness and the use of one and the same formulation to make these electrodes.

Thanks to the presence of two types of groups as defined hereinabove, the redox compound used in the cells of the invention may be qualified as a biredox compound, as the group capable of capturing electrons (which may also be qualified as a group reducing reversibly at low potential) belongs to a first redox pair and the second group capable of donating electrons (which may also be qualified as a group oxidizing reversibly at high potential) belongs to a second redox pair.

Suitable redox compounds may be compounds, in which the group(s) capable of capturing electrons may be:
conjugated carbonyl groups, such as quinones;
carboxylate groups, such as lithiated carboxylate groups;
disulphide groups;
azo groups;
imide groups (for example, polyimide groups); or
heteraromatic groups, such as polyviologenic groups;
and/or in which the group(s) capable of donating electrons may be:
enol or enolate groups;
nitroxide groups;
thioether groups; or
aromatic amine groups, such as dianiline derivatives.

Specific compounds meeting these criteria are compounds comprising, both at least one group selected from among conjugated carbonyl groups; carboxylate groups, disulphide groups and at least one group selected from among enol or enolate groups, nitroxide groups and thioether groups.

It is specified that by conjugated carbonyl groups, it should be understood two carbonyl groups conjugated via one or more double bond(s), these conjugated carbonyl groups being possibly schematised by the following simplified formula (I):

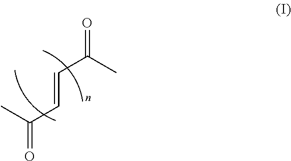

n being an integer equal to at least 1.

It is specified that, by enolic or enolate group, it should be understood a group respectively meeting the following simplified formulas (II) and (Ill):

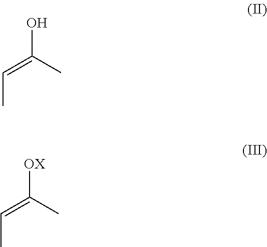

wherein X represents a monovalent cation such as lithium.

Redox compounds meeting the above-mentioned specificities may be quinone compounds, which designate hydrocarbon compounds comprising one or more benzene ring(s), on which two hydrogen atoms are replaced by two oxygen atoms thus each forming a double bond with a carbon atom, such compounds thus comprising two conjugated carbonyl groups capable of capturing electrons, which quinone compounds should also be substituted by at least one substituent comprising at least one group capable of donating electrons, such as an enolate group, a nitroxide group, a thioether group.

In particular, the redox compounds of the family of quinone compounds have the advantage of having a low environmental impact, of being often inexpensive and could be derived from a biological origin (some quinone compounds found in plants, fungi, bacteria and possibly in some animals).

More specifically, the quinone compounds may be selected from among benzoquinone compounds (such as 1,4-benzoquinone compounds, 1,2-benzoquinone compounds), naphthoquinone compounds (such as 1,4-naphthoquinone compounds, 1,2-naphthoquinone compounds, 1,5-naphthoquinone compounds, 1,7-naphthoquinone compounds, 2,3-naphthoquinone compounds, 2,6-naphthoquinone compounds) and anthraquinone compounds (such as 9,10-anthraquinone compounds, 1,2-anthraquinone compounds, 1,4-anthraquinone compounds, 1,10-anthraquinone compounds, 2,9-anthraquinone compounds, 1,5-anthraquinone compounds, 1,7-anthraquinone compounds, 2,3-anthraquinone compounds, 2,6-anthraquinone compounds), these compounds comprising at least one substituent comprising at least one group capable of donating electrons, such as an enolate group, a nitroxide group, a thioether group and, possibly, at least one other substituent selected from among —N(CH₃)₂, —NH₂, —OR, —OH, —SH, —CH₃, —SiR₃, —F, —Cl, —C₂H₃, —CHO, —COOCH₃, —CF₃, —CN, —COOH, —PO₃H₂, —SO₃H, NO₂, —COOM, —COOR, —SO₃M, —COR, —C═NCHR′R″, with R, R′ and R″ representing, independently of each other, H or an alkyl group and M representing Li, Na, K or Mg.

Still more specifically, it may consist of an anthraquinone compound, such as a 9,10-anthraquinone compound, comprising at least one substituent comprising at least one group capable of donating electrons, a particular redox compound meeting the above-mentioned characteristics, corresponding to the following formula (IV):

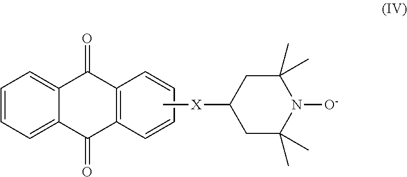

wherein X is an organic spacer group or a single bond, i.e. the tetramethylpiperidinyloxy group is directly bonded to one of the carbon atoms of the ring.

For clarity, the —X— bond intersecting the ring indicates that the tetramethylpiperidinyloxy group could be bonded to any one of the carbon atoms of the anthraquinone ring either directly or via the organic spacer group.

More specifically, this redox compound may correspond to the following formula (V):

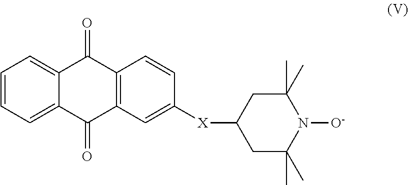

with X being as defined hereinabove.

When X represents an organic spacer group, it may be an imidazolium group, the counterion of which may be, for example, a halogen anion, a TFSI anion (TFSI being the abbreviation corresponding to bis(trifluoromethane)sulfonimide), a TfO anion (TfO being the abbreviation corresponding to trifluoromethanesulfonate).

During the operation of the battery (i.e. when the latter is discharging), the above-mentioned specific redox compound undergoes a reduction reaction at each positive electrode, this reaction being possibly represented by the following chemical equation (VI):

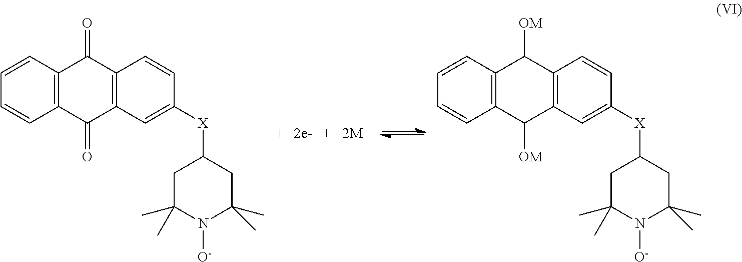

M⁺ representing a cation;

whereas the same redox compound undergoes an oxidation reaction at each negative electrode, this reaction being possibly represented by the following chemical equation (VII):

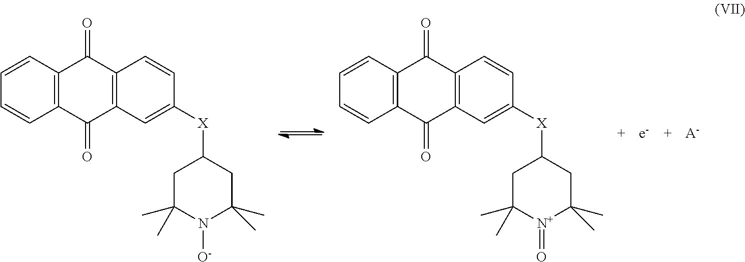

Other redox compounds meeting the above-mentioned specificities may be quinone compounds in their enolate form, i.e. whose conjugated carbonyl groups ═C—CO— are transformed into groups —C═COX— (with X being a monovalent cation, such as lithium), which quinone compounds are also substituted by at least one group capable of capturing electrons, such as a carboxylate group, and possibly by another substituent selected from among —N(CH₃)₂, —NH₂, —OR, —OH, —SH, —CH₃, —SiR₃, —F, —Cl, —C₂H₃, —CHO, —COOCH₃, —CF₃, —CN, —COOH, —PO₃H₂, —SO₃H, NO₂, —COOM, —COOR, —SO₃M, —COR, —C═NCHR′R″, with R, R′ and R″ representing, independently one of another, H or an alkyl group and M representing Li, Na, K or Mg.

More specifically, it may consist of a benzoquinone compound in an enolate form substituted by at least one carboxylate group, and even more specifically a 1,4-benzoquinone compound substituted by at least one carboxylate group (for example, two carboxylate groups) and possibly another substituent such as those defined hereinabove, an example of this type meeting the following formula (VIII):

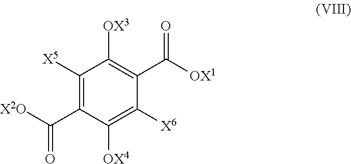

wherein X¹ to X⁴ represent, independently of each other, a cation and X⁵ and X⁶ represent, independently of each other, a hydrogen atom or an —SO₃H group, a particular compound meeting this specificity being that one of the following formula (IX):

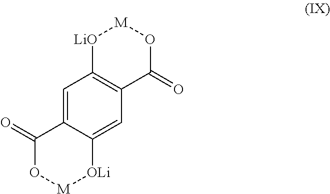

with M representing a divalent cation, such as a magnesium cation, M establishing a bridge between the oxygen atom of the carboxylate group and the oxygen atom of the enolate group.

During the operation of the battery (i.e. when the latter is discharging), the redox compound of the aforementioned formula (VIII) undergoes a reduction reaction of the carboxylate groups at each positive electrode, this reaction being possibly represented by the following chemical equation (X):

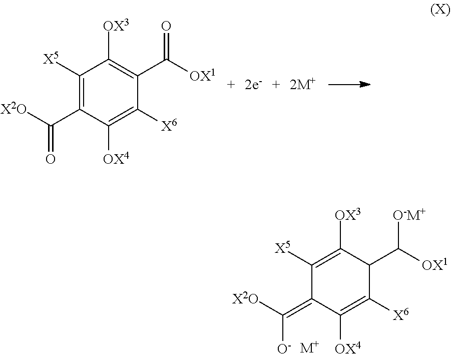

whereas the same redox compound undergoes an oxidation reaction of the enolate groups at each negative electrode, this reaction being possibly represented by the following chemical equation (XI):

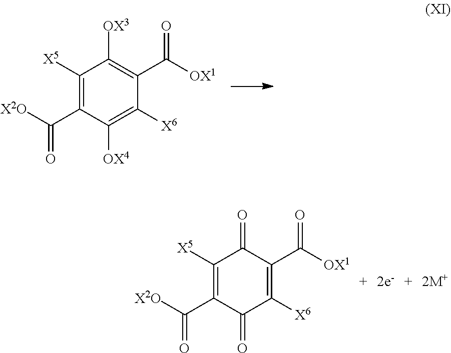

In addition to an active material as defined hereinabove, the negative electrodes and the positive electrodes of the battery may comprise electronically-conductive additives, i.e. additives capable of conferring on the electrode, in which they are incorporated, an electronic conductivity, these additives possibly being, for example, carbonaceous materials such as carbon black, carbon nanotubes, carbon fibres (in particular, carbon fibres obtained in the vapour phase known by the abbreviation VGCF), graphite in powder form, graphite fibres and mixtures thereof. The negative electrodes and the positive electrodes may further comprise one or more organic binder(s), the organic binder(s) possibly being, in particular, polymeric binders, such as:
fluorinated (co)polymers, such as a polytetrafluoroethylene (known by the abbreviation PTFE), polyvinylidene fluoride (known by the abbreviation PVDF), poly(vinylidene fluoride-co-hexafluoropropylene) (known by the abbreviation PVDF-HFP);
elastomeric polymers, such as a styrene-butadiene copolymer (known by the abbreviation SBR), an ethylene-propylene-diene monomer copolymer (known by the abbreviation EPDM);
polymers from the family of polyvinyl alcohols;
cellulosic polymers, such as carboxymethylcellulose (known by the abbreviation CMC);
polymers from the family of poly(meth)acrylates, such as polymethyl methacrylate (known by the abbreviation PMMA);
polymers from the family of polyacrylic acids (known by the abbreviation PAA); and
mixtures thereof.

In this context, the electrodes are thus presented, with regards to their constitution, in the form of a composite material comprising a polymeric matrix consisting of one or more polymeric binders, such as those mentioned hereinabove and, comprising, as fillers, at least one active material as defined and, possibly, one or more electronically-conductive additive(s), such as those defined hereinabove.

Alternatively, the electrodes may be, advantageously, in particular in gelled polymer electrolyte systems, gelled electrodes, which means that, besides the presence of an active material as defined hereinabove, they comprise (and possibly consist of) a composite material comprising (and possibly consisting of) a polymeric matrix conventionally formed of at least one polymer capable of gelling (which may be called gelling polymer(s) (FF)) on contact with a liquid electrolyte, the electrode active material and possibly one or more electronically-conductive additive(s), such as those mentioned hereinabove, the liquid electrolyte being confined within the polymeric matrix, which electrolyte preferably being of the same nature as that of the electrolytic constituent disposed between the positive electrode and the negative electrode of each cell, which electrolytic constituent being, advantageously, a liquid electrolyte confined within a gelled polymer membrane.

In this case, the gelling polymer(s) (FF) are advantageously selected from among fluorinated polymers comprising at least one repeating unit resulting from the polymerisation of a fluorinated monomer and, preferably, at least one repeating unit resulting from the polymerisation of a monomer comprising at least one carboxylic acid group, possibly in the form of a salt.

As regards the gelling polymers (FF), the repeating unit(s) resulting from the polymerisation of a fluorinated monomer may, more specifically, be one or more repeating unit(s) resulting from the polymerisation of one or more ethylenic monomer(s) comprising at least one fluorine atom and possibly one or more other halogen atom(s), examples of monomers of this type being the following ones:
C₂-C₈ perfluoroolefins, such as tetrafluoroethylene, hexafluoropropene (also known by the abbreviation HFP);
C₂-C₈ hydrogenated fluoroolefins, such as vinylidene fluoride, vinyl fluoride, 1,2-difluoroethylene and trifluoroethylene;
perfluoroalkylethylenes of formula CH₂═CHR¹, wherein R¹ is a C₁-C₆ perfluoroalkyl group;
C₂-C₆ fluoroolefins including one or more other halogen atom(s) (such as chlorine, bromine, iodine), such as chlorotrifluoroethylene;
(per)fluoroalkylvinyl ethers of formula CF₂═CFOR², wherein R² is a C₁-C₆ fluoro- or perfluoroalkyl group, such as CF₃, C₂F₅, C₃F₇;
monomers of formula CF₂═CFOR³, wherein R³ is a C₁-C₁₂ alkyl group, a C₁-C₁₂ alkoxy group or a C₁-C₁₂ (per)fluoroalkoxy group, such as a perfluoro-2-propoxypropyl group; and/or
monomers of formula CF₂═CFOCF₂OR⁴, wherein R⁴ is a C₁-C₆ fluoro- or perfluoroalkyl group, such as CF₂, C₂F₅, C₃F₇, or a C₁-C₆ fluoro- or perfluoroalkoxy group, such as —C₂F₅—O—CF₃.

More particularly, the gelling polymer(s) (FF) may comprise, as repeating unit(s) resulting from the polymerisation of a fluorinated monomer, a repeating unit resulting from the polymerisation of a monomer from the category of C₂-C₈ perfluoroolefins, such as hexafluoropropene and a repeating unit resulting from the polymerisation of a monomer from the category of C₂-C₈ hydrogenated fluoroolefins, such as vinylidene fluoride.

The repeating unit(s) resulting from the polymerisation of a monomer comprising at least one carboxylic acid group, possibly in the form of a salt, may more specifically be one or more repeating unit(s) resulting from the polymerisation of a monomer of the following formula (XII):

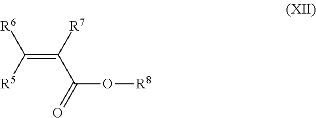

wherein R⁵ to R⁷ represent, independently of each other, a hydrogen atom or a C₁-C₃ alkyl group and R⁸ represents a hydrogen atom or a monovalent cation (for example, an alkaline cation, an ammonium cation), particular examples of such monomers being acrylic acid or methacrylic acid.

Particular gelling polymers (FF) that can be used in the context of the invention may be polymers comprising a repeating unit resulting from the polymerisation of vinylidene fluoride, a repeating unit resulting from the polymerisation of a monomer comprising at least one carboxylic acid group, such as acrylic acid and possibly a repeating unit resulting from the polymerisation of a fluorinated monomer other than vinylidene fluoride (and more specifically, a repeating unit resulting from the polymerisation of hexafluoropropene).

Still more particularly, gelling polymers (FF) that can be used in the context of the invention are gelling polymers, the aforementioned repeating units of which are derived from the polymerisation:
of at least 70% by mole of a C₂-C₈ hydrogenated fluoroolefin, preferably vinylidene fluoride;
from 0.1 to 15% by mole of a C₂-C₈ perfluoroolefin, preferably hexafluoropropene; and
from 0.01 to 20% by mole of a monomer of the aforementioned formula (I), preferably, acrylic acid.

Moreover, the gelling polymer(s) (FF) advantageously have an intrinsic viscosity measured at 25° C. in N,N-dimethylformamide ranging from 0.1 to 1.0 L/g, preferably from 0.25 at 0.45 L/g.

More specifically, the intrinsic viscosity is determined by the equation hereinbelow based on the drop time, at 25° C., of a solution obtained by dissolving the considered polymer in a solvent (N,N-dimethylformamide) at a concentration of about 0.2 g/dL using an Ubbelhode viscometer:

$$[ η ] = \frac{{η}_{sp} + Γ \cdot ln {η}_{r}}{( 1 + Γ ) \cdot c}$$

wherein:
q corresponds to the intrinsic viscosity (in dL/g);
c corresponds to the polymer concentration (in g/dL);
ηᵣ corresponds to the relative viscosity, i.e. the ratio between the drop time of the solution and the drop time of the solvent;
ηₛₚ corresponds to the specific viscosity, i.e. ηᵣ−1;

Γ corresponds to an experimental factor set at 3 for the considered polymer.

Advantageously, all negative electrodes of the battery meet the same specificities (namely, in terms of composition and dimensions) just as all positive electrodes of the battery also meet the same specificities in terms of composition and dimensions.

As regards the gelled electrodes, they may comprise a liquid electrolyte trapped within the polymeric matrix.

In this case, the liquid electrolyte trapped within the gelled electrodes is, conventionally, an ion-conducting electrolyte, which may comprise (and possibly consists of) at least one organic solvent, at least one metal salt and possibly a compound from the family of vinyl compounds.

The organic solvent(s) may be carbonate solvents and, more specifically:
cyclic carbonate solvents, such as ethylene carbonate (symbolised by the abbreviation EC), propylene carbon (symbolised by the abbreviation PC), butylene carbonate, vinylene carbonate, fluoroethylene carbonate, fluoropropylene carbonate and mixtures thereof;
linear carbonate solvents, such as diethyl carbonate (symbolised by the abbreviation DEC), dimethyl carbonate (symbolised by the abbreviation DMC), ethyl methyl carbonate (symbolised by the abbreviation EMC) and mixtures thereof.

The organic solvent(s) may also be ester solvents (such as ethyl propionate, n-propyl propionate), nitrile solvents (such as acetonitrile) or ether solvents (such as dimethyl ether, 1,2-dimethoxyethane).

The organic solvent(s) may also be ionic liquids, i.e., conventionally, compounds formed by the combination of a positively charged cation and a negatively charged anion, which is in the liquid state at temperatures below 100° C. under atmospheric pressure.

More specifically, ionic liquids may comprise:
a cation selected from among imidazolium, pyridinium, pyrrolidinium, piperidinium cations, said cations possibly being substituted by at least one alkyl group comprising from 1 to 30 carbon atoms;
an anion selected from among halide anions, perfluorinated anions, borates.

Still more specifically, the cation may be selected from among the following cations:
a pyrrolidinium cation of the following formula (XIII):

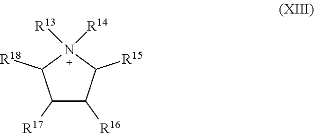

wherein R¹³ and R¹⁴ represent, independently of each other, a C₁-C₈ alkyl group and R¹⁵, R¹⁶, R¹⁷ and R¹⁸ represent, independently of each other, a hydrogen atom or a C₁-C₃₀ alkyl group, preferably a C₁-C₁₈ alkyl group, more preferably a C₁-C₈ alkyl group;
a piperidinium cation of the following formula (XIV):

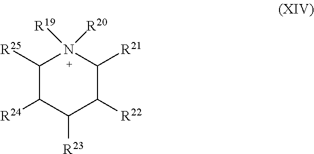

wherein R¹⁹ and R²⁰ represent, independently of each other, a C₁-C₈ alkyl group and R²¹, R²², R²³, R²⁴ and R²⁵ represent, independently of each other, a hydrogen atom or a C₁-C₃₀ alkyl group, preferably a C₁-C₁₈ alkyl group, more preferably a C₁-C₈ alkyl group;
a quaternary ammonium cation;
a quaternary phosphonium cation;
an imidazolium cation; or
a pyrazolium cation.

In particular, the positively charged cation may be selected from among the following cations:
a pyrrolidinium cation of the following formula (XIII-A):

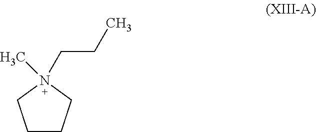

a piperidinium cation of the following formula (XIV-A):

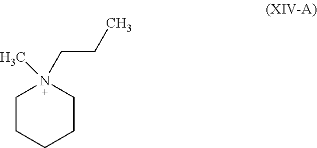

Specifically, the negatively charged anion may be selected from among:
4,5-dicyano-2-(trifluoromethyl)imidazole (known by the abbreviation TDI);
bis(fluorosulfonyl)imide (known by the abbreviation FSI);
bis(trifluoromethylsulfonyl)imide of formula (SO₂CF₃)₂N⁻;
hexafluorophosphate of formula PF₆⁻;
tetrafluoroborate of formula BF₄⁻;
the oxaloborate of the following formula (XV):

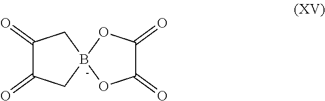

A specific ionic liquid which can be used according to the invention may be an ionic liquid composed of a cation of formula (XIII-A) as defined hereinabove and an anion of formula (SO₂CF₃)₂N⁻, PF₆⁻ or BF₄⁻.

The metal salt(s) may be selected from among the salts of the following formulas: MeI, Me(PF₆)ₙ, Me(BF₄)n, Me(ClO₄)ₙ, Me(bis(oxalato)borate)ₙ (which may be designated by the abbreviation Me(BOB)ₙ), MeCF₃SO₃, Me[N(FSO₂)₂]ₙ, Me[N(CF₃SO₂)₂]ₙ, Me[N(C₂F₅SO₂)₂]ₙ, Me[N(CF₃SO₂)(R_{F}SO₂)]ₙ, wherein R_{F} is a group —C₂F₅, —C₄F₉ or —CF₃OCF₂CF₃, Me(AsF₆)ₙ, Me[C(CF₃SO₂)₃]ₙ, Me₂Sn, Me(C₆F₃N₄) (C₆F₃N₄ corresponding to 4,5-dicyano-2-(trifluoromethyl)imidazole and, when Me is Li, the salt corresponds to lithium 4,5-dicyano-2-(trifluoromethyl)imidazole, this salt being known by the abbreviation LiTDI), wherein Me is a metallic element and, preferably, a metallic transition element, an alkaline element or an alkaline-earth element and, more preferably, Me is Li (in particular, when the battery of the invention is a lithium-ion or lithium-air battery), Na (in particular, when the battery is a sodium-ion battery), K (in particular, when the battery is a potassium-ion battery), Cs, Mg (in particular, when the battery is a Mg-ion battery), Ca (in particular, when the battery is a calcium-ion battery) and Al (in particular, when the battery is an aluminium-ion battery) and n corresponds to the degree of valence of the metallic element (typically, 1, 2 or 3).

When Me is Li, the salt is preferably LiPF₆.

Advantageously, the concentration of the metal salt in the liquid electrolyte is at least 0.01 M, preferably at least 0.025 M and more preferably at least 0.05 M and, advantageously, at most 5 M, preferably at most 2 M and more preferably at most 1 M.

Furthermore, the liquid electrolyte may comprise an additive belonging to the category of vinyl compounds, such as vinylene carbonate, this additive being included in the electrolyte at a content not exceeding 5% by weight of the total weight of the electrolyte.

A liquid electrolyte that can be used in the batteries of the invention, in particular when it consists of a lithium-ion battery, is an electrolyte comprising a mixture of carbonate solvents (for example, a mixture of cyclic carbonate solvents, such as a mixture of ethylene carbonate and propylene carbonate and present, for example, in the same volume), a lithium salt, for example, LiPF₆ (for example, 1 M) and vinylene carbonate (for example, present up to 2% by weight with respect to the total weight of the liquid electrolyte).

Furthermore, the positive electrode(s) and/or the negative electrode(s) may have a thickness ranging from 2 μm to 500 μm, preferably from 10 μm to 400 μm and, more preferably, a thickness ranging from 50 μm to 300 μm.

Thanks to the gelled nature of the electrodes, it is possible to access larger thicknesses than conventional non-gelled electrodes, which allows incorporating more active material and thus accessing greater on-board energy.

Furthermore, each electrochemical cell includes an electrolytic component disposed between the positive electrode and the negative electrode.

This electrolytic constituent may be of different natures.

According to a first variant, the electrolytic constituent may be a liquid electrolyte trapped in a separator.

Conventionally, this separator soaked in liquid electrolyte also enables an ionic conduction (namely, the passage of ions from the negative electrode to the positive electrode and vice versa, depending on whether the charging or discharging process is taking place). Furthermore, it advantageously allows confining the liquid electrolyte, which liquid electrolyte could meet the same specific characteristics as those set out hereinabove with regards to gelled electrodes, in particular in terms of ingredients (organic solvents, salts, concentrations . . . ).

More specifically, this separator may consist of a membrane made of a material selected from among glass fibres (and more specifically, a fibreglass matt), a polymeric material, such as a polyterephthalate (such as a polyethylene terephthalate, known by the abbreviation PET), a polyolefin (for example, a polyethylene, a polypropylene), a polyvinyl alcohol, a polyamide, a polytetrafluoroethylene (known by the abbreviation PTFE), a polyvinyl chloride (known by the abbreviation PVC), a polyvinylidene fluoride (known by the abbreviation PVDF). The separator may have a thickness ranging from 5 to 300 μm.

According to a second variant, the electrolytic constituent may be a solid electrolyte, such as an electrolyte selected from among the following categories:
a glass or ceramic which conducts lithium ions in a purely solid form, for example, a thin layer deposited by chemical vapor deposition (CVD) such as a LIPON layer, or a layer of a composite material comprising a polymeric matrix, for example polyvinylidene fluoride, and a filler consisting of a lithiated oxide, such as Li₇La₃Zr₂O₁₂;
a dry solid polymer electrolyte composed of a polymer of the polyethylene oxide (PEO) type and of a lithium salt, for example, lithium trifluorosulfonylimidide (LiTFSI); or
a hybrid solid electrolyte consisting of a polymeric matrix loaded with a lithium salt and with lithium-conducting glass or ceramic.

Finally, according to a third variant, the electrolytic constituent may be a gelled polymer electrolyte, wherein a liquid electrolyte is confined within a gelled polymer membrane, this membrane advantageously comprising an organic portion comprising (or consisting of) at least one fluorinated polymer (F) comprising at least one repeating unit resulting from the polymerisation of a fluorinated monomer and at least one repeating unit resulting from the polymerisation of a monomer comprising at least one hydroxyl group, possibly in the form of a salt, and comprising an inorganic portion formed, entirely or partly, of one or more oxide(s) of at least one element M selected from among Si, Ti and Zr and combinations thereof.

The liquid electrolyte may meet the same specific characteristics as those set out hereinabove with regards to the gelled electrodes, in particular in terms of ingredients (organic solvents, salts, concentrations . . . ).

For the fluorinated polymer (F), the repeating unit(s) resulting from the polymerisation of a fluorinated monomer may, more specifically, be one or more repeating unit(s) resulting from the polymerisation of one or more ethylenic monomer(s) comprising at least one fluorine atom and possibly one or more other halogen atom(s), examples of monomers of this type being the following ones:
C₂-C₈ perfluoroolefins, such as tetrafluoroethylene, hexafluoropropene (also known by the abbreviation HFP);
C₂-C₈ hydrogenated fluoroolefins, such as vinylidene fluoride, vinyl fluoride, 1,2-difluoroethylene and trifluoroethylene;
perfluoroalkylethylenes of formula CH₂═CHR¹, wherein R¹ is a C₁-C₆ perfluoroalkyl group;
C₂-C₆ fluoroolefins comprising one or more other halogen atom(s) (such as chlorine, bromine, iodine), such as chlorotrifluoroethylene;
(per)fluoroalkylvinyl ethers of formula CF₂═CFOR², wherein R² is a C₁-C₆ fluoro- or perfluoroalkyl group, such as CF₃, C₂F₅, C₃F₇;
monomers of formula CF₂═CFOR³, wherein R³ is a C₁-C₁₂ alkyl group, a C₁-C₁₂ alkoxy group or a C₁-C₁₂ (per)fluoroalkoxy group, such as a perfluoro-2-propoxypropyl group; and/or
monomers of formula CF₂═CFOCF₂OR⁴, in which R⁴ is a C₁-C₆ fluoro- or perfluoroalkyl group, such as CF₂, C₂F₅, C₃F₇, or a C₁-C₆ fluoro- or perfluoroalkoxy group, such as —C₂F₅—O—CF₃.

More particularly, the fluorinated polymer (F) may comprise, as repeating units resulting from the polymerisation of a fluorinated monomer, a repeating unit resulting from the polymerisation of a monomer from the category of C₂-C₈ perfluoroolefins, such as hexafluoropropene and a repeating unit resulting from the polymerisation of a monomer from the category of C₂-C₈ hydrogenated fluoroolefins, such as vinylidene fluoride.

Still for the fluorinated polymer (F), the repeating unit(s) resulting from the polymerisation of a monomer comprising at least one hydroxyl group, possibly in the form of a salt, may, more specifically, be one or more repeating unit(s) resulting from the polymerisation of a monomer of the following formula (XVI):

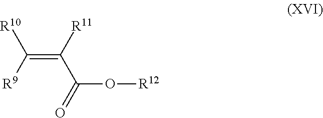

wherein R⁹ to R¹¹ represent, independently of each other, a hydrogen atom or a C₁-C₃ alkyl group and R¹² is a C₁-C₅ hydrocarbon group comprising at least one hydroxyl group, examples of such monomers being hydroxyethyl (meth)acrylate monomers, hydroxypropyl (meth)acrylate monomers.

More particularly, the fluorinated polymer (F) may comprise, as a repeating unit resulting from the polymerisation of a monomer comprising at least one hydroxyl group, a repeating unit resulting from the polymerisation of one of the monomers of the following formulas (XVII) to (XIX):

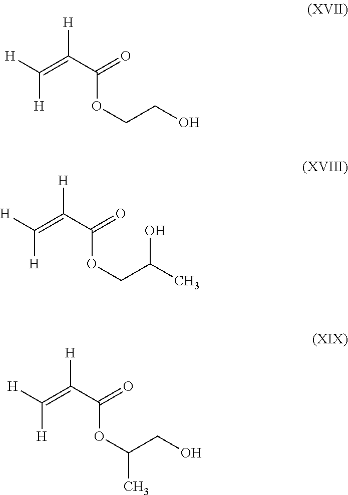

and, preferably a repeating unit resulting from the polymerisation of the monomer of the aforementioned formula (XVII), this monomer corresponding to 2-hydroxyethyl acrylate (also known by the abbreviation HEA).

Thus, particular fluorinated polymers (F) that can be used in the context of the invention to form the membranes may be polymers comprising, as repeating units resulting from the polymerisation of a fluorinated monomer, a repeating unit resulting from the polymerisation of a monomer from the category of C₂-C₈ perfluoroolefins, such as hexafluoropropene and a repeating unit resulting from the polymerisation of a monomer from the category of C₂-C₈ hydrogenated fluoroolefins, such as vinylidene fluoride, and comprising, as a repeating unit resulting from the polymerisation of a monomer comprising at least one hydroxyl group, a repeating unit resulting from the polymerisation of a monomer of the previously-defined formula (XVI) and, still more specifically, a polymer whose aforementioned repeating units result from the polymerisation:
of at least 70% by mole of a C₂-C₈ hydrogenated fluoroolefin, preferably vinylidene fluoride;
from 0.1 to 15% by mole of a C₂-C₈ perfluoroolefin, preferably hexafluoropropene; and
from 0.01 to 20% by mole of a monomer of formula (IV), preferably, 2-hydroxyethyl acrylate.

Advantageously, the inorganic portion formed, at least in part, of one or more oxide(s) of at least one element M selected from among Si, Ti and Zr and the combinations thereof is, entirely or partly, chemically bonded to the organic portion via the hydroxyl groups.

Gelled polymer electrolytes comprising a matrix, in which the organic portion is chemically bonded to the inorganic portion, as described hereinabove, are described in particular in WO 2013/072216.

Advantageously, the membranes of the invention have a surface which entirely covers the surface of the negative electrodes, with which they are in contact (so as to ensure a neat separation with the positive electrode) yet, with the condition of not projecting beyond the face of the current collector receiving the negative electrode, except to take the risk of creating an ionic short-circuit by bringing it into contact with the membrane of the adjacent cell during the process of assembling the different constituent elements of the batteries.

Advantageously, the batteries of the invention have, as positive and negative electrodes, gelled electrodes as defined hereinabove and, as an electrolytic constituent, a liquid electrolyte confined in a gelled polymer membrane as defined hereinabove in the third variant.

Thanks to the use of gelled electrodes and gelled membranes, the following advantages are obtained:
the liquid electrolyte being confined in the gelled electrodes and the gelled membrane(s) which separate the electrodes, there is no leakage of electrolyte between the compartments of the bipolar battery, which allows avoiding ionic short-circuits and obtaining a stable cycling behaviour for all regimes, including slow regime and that being so for a large number of cycles;
because of the confinement of the liquid electrolyte in the gelled electrodes and the gelled membranes, it is not necessary to have specifically tight seals at the periphery of the electrodes;
during the manufacture of the bipolar battery, it is not necessary to proceed with an electrolyte filling step for each of the stacked cells before closing the packaging, the liquid electrolyte being already contained in the gelled electrodes and gelled membranes, which results in time savings in the manufacturing process and to easy handling;
the possibility for these gelled electrodes to also prevent, by their affinity for liquid electrolytes, the leakage of liquid electrolyte from the gelled membranes which are in contact with the gelled electrodes.

The batteries of the invention are batteries with a bipolar architecture, which supposes the presence of bipolar current collector(s) between two adjacent cells.

More specifically, the bipolar current collector (when the battery includes only two cells) or the bipolar current collectors (when the battery includes more than two cells) may be defined as current collectors that separate two adjacent electrochemical cells from each other and which support on a first face an electrode of one of these electrochemical cells and on a second face opposite to the first face an electrode with an opposite sign of the other one of these electrochemical cells.

Moreover, an electrochemical cell is considered to be adjacent to another electrochemical cell when it immediately precedes or follows the latter in the stack and is therefore separated therefrom only by a bipolar current collector.

It should be understood that the electrochemical cells are conventionally ionically isolated from each other, in particular by the presence of the bipolar current collector.

The batteries of the invention also comprise terminal current collectors generally positioned at the ends of the stack and which receive, on one of their faces, an electrode layer belonging to a terminal cell (this electrode layer being a positive electrode layer or a negative electrode layer depending on the desired polarity), this electrode layer, conventionally, having an identical constitution as that of an electrode layer of the same polarity associated with a bipolar current collector.

The current collector(s), whether they are terminal or bipolar, may be single-layer, in which case they preferably consist of a metal sheet otherwise of two joined sheets. For example, they have a 20 μm thickness.

Advantageously, the current collector(s), whether terminal or bipolar, may consist of an electrically-conductive sheet, for example, based on carbon or at least one metal (for example, a monometallic or bimetallic sheet), such as an aluminium or aluminium-copper sheet.

Whether for the bipolar current collectors or the terminal collectors, the face(s) occupied by an electrode advantageously have, at their periphery, a free edge (i.e. not occupied by the electrode) and/or at least one tab in contact with the collector(s) or extending the latter, all or part of these free edges and/or tabs being covered, entirely or partly, by an insulating material layer. More specifically, each pair of current collectors facing each other via a free edge and/or a tab may comprise for at least one of them an insulating material layer covering all or part of the free edge and/or the tab.

Furthermore, the batteries of the invention may include a packaging intended, as its name indicates, to package the different constituent elements of the stack.

This packaging may be flexible (in which case it is, for example, made from a laminated film comprising a frame in the form of an aluminium foil which is coated over its external surface with a layer of polyethylene terephthalate (PET) or of a polyamide and which is coated over its internal surface with a layer of polypropylene (PP) or polyethylene (PE)) or else rigid (in which case, it is, for example, made of a light and inexpensive metal such as stainless steel, aluminium or titanium, or a thermoset resin such as an epoxy resin) depending on the targeted application type.

The number n of electrochemical cells that the batteries of the invention may include is selected so as to obtain a satisfactory total voltage Utot according to the applications for which this battery is intended, according to the rule Utot=n×Un, with Un corresponding to the voltage of the used electrochemical pair. Typically, n may be comprised between 2 and 20 with the batteries of the invention.

The batteries of the invention may find application in the production of electric or hybrid vehicles, stationary energy storage devices and mobile electronic devices (telephones, touch pads, computers, cameras, camcorders, hand tools, sensors, etc.).

The batteries of the invention may be prepared by a method comprising a step of assembling the base elements, which are the bipolar current collector(s) coated over two opposite faces, respectively, by a positive electrode and a negative electrode (the number of current collectors to be assembled corresponding to (n−1) with n corresponding to the number of cells of the battery), the membranes as defined hereinabove and the terminal current collectors coated over one of their faces, for one, a negative electrode and for the other one a positive electrode.

Each membrane may be interposed between the positive electrode and the negative electrode of each cell, which means, in other words, that it existed before the formation of this stack or it may be deposited (by any solution deposition technique, such as coating, casting or printing) over one face of one amongst the positive or negative electrodes of each cell.

The different basic elements may be prepared beforehand before assembly, in particular as regards the positive and negative electrodes.

Thus, in particular, the positive and negative electrodes may be made by depositing a composition comprising the constituent ingredients of the electrodes (gelling polymer (FF), active material, liquid electrolyte and possibly at least one electronically-conductive additive as defined hereinabove) over the current collectors by a solution deposition technique (for example, coating, printing, casting) followed by drying.

More specifically, the positive and negative electrodes may be prepared by a method comprising the following steps:
providing a current collector;
(ii) providing a composition comprising
at least one gelling polymer (FF) as defined hereinabove;
at least the electrode active material, which is a redox organic compound;
a liquid electrolyte;
possibly, one or more electronic conductive additive(s);
(iii) applying the composition of step (ii) over the current collector of step (i), whereby an assembly results comprising the current collector coated with at least one layer of said composition; and
(iv) drying the assembly resulting from step (iii).

According to step (iii), the composition may be applied over a current collector by any type of application process, for example by casting, printing or coating, for example using a roller.

Step (iii) may be repeated typically once or several times, according to the desired electrode thickness.

The ingredients of the composition may correspond to the same variations as those already defined for these same ingredients in the context of the description of the electrodes as such.

It should be noted that the composition advantageously comprises an organic solvent selected so as to enable the solubilisation of the gelling polymer(s) (FF), this organic solvent possibly being that of the liquid electrolyte or possibly being added in addition to the aforementioned other ingredients.

To guarantee uniform properties for all positive and negative electrodes of the battery, these may be derived from the same deposition layer (with a given composition for the positive electrode and a given composition for the negative electrode) deposited over a substrate composed of the constituent material of the different current collectors followed by an appropriate cutting of this substrate to provide the different current collectors coated with electrode(s).

Coated in this way, the different current collectors may be provided with metal tabs to ensure current pick-up, in the case of terminal current collectors, or for voltage control, in the case of bipolar current collectors and may be coated with a layer of insulating material over their free edge and/or over the tabs as already described hereinabove.

When they meet the specific definition given hereinabove, the membranes could be obtained by a process comprising a hydrolysis-condensation step, in the presence of a liquid electrolyte and a fluorinated polymer (F) as defined hereinabove, of at least one organometallic compound comprising a metallic element selected from among Si, Ti, Zr and combinations thereof, a reaction taking place, advantageously between the organometallic compound and the fluorinated polymer (F), further details being given in the international application WO 2020/012123.

### BRIEF DESCRIPTION OF THE FIGURES

Other advantages and features of the invention will appear from the following complementary detailed description, which is given as an illustration of the invention and which refers to the appended figures wherein:

FIG. 1, already discussed, schematically represents a longitudinal sectional view of a conventional example of a battery with a bipolar architecture;

FIG. 2 is a graph illustrating the evolution of the potential U (in V vs Li⁺/Li) as a function of the specific capacitance C (in mAh·g⁻¹) for 6 consecutive cycles (respectively curve 1 for cycle 1, curve 2 for the cycle 2, curve 3 for cycle 3, curve 4 for cycle 4, curve 5 for cycle 5 and curve 6 for cycle 6) of the button cell illustrated in Example 1;

FIG. 3 is a graph illustrating the evolution of the potential U (in V vs Li⁺/Li) as a function of the specific capacitance C (in mAh·g⁻¹) for 6 consecutive cycles (respectively curve 1 for cycle 1, curve 2 for the cycle 2, curve 3 for cycle 3, curve 4 for cycle 4, curve 5 for cycle 5 and curve 6 for cycle 6).

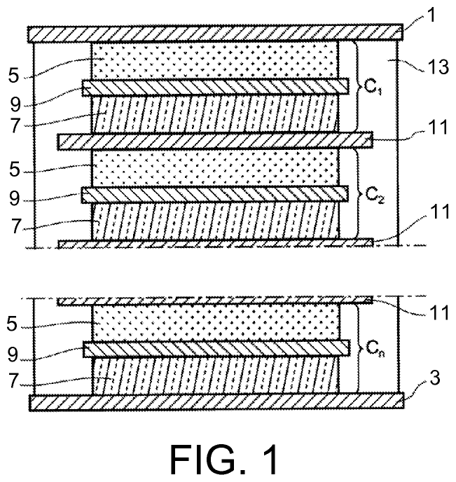

### DETAILED DESCRIPTION OF PARTICULAR EMBODIMENTS

### Example 1

In this example, the preparation of a lithium battery with a bipolar architecture in accordance with the invention is described involving the following steps:
Preparation of the active material;
2) Preparation of the gelled electrodes;
3) Preparation of the gelled membrane;
4) Preparation of the battery.

Preparation of the Active Material

First of all, the biredox organic active material intended to be part of the constitution of the electrodes is prepared, this material corresponding to the following formula:

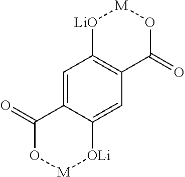

with M representing magnesium.

To do so, 5.2 g of dihydroxyterephthalic acid are dispersed in 500 mL of water, to which 1.53 g of magnesium hydroxide are added. The suspension is stirred for 48 hours at room temperature before removing the water under reduced pressure. A beige powder is obtained with a substantial yield.

Afterwards, 1 g of the powder obtained before is dispersed in 25 mL of degassed water, to which 2 equivalents of lithium hydroxide are added under an inert atmosphere. The mixture is stirred for 16 hours with evaporation of the water under reduced pressure. A yellow powder is obtained with a substantial yield. It is treated under vacuum at 235° C. for 48 hours.

2—Preparation of the Gelled Electrodes

For the preparation of the inks intended for the preparation of the electrodes, the same gelling polymer is used, whether for the positive electrode or the negative electrode. This consists of the polymer comprising repeating units resulting from the polymerisation of vinylidene fluoride (96.7% by mole), acrylic acid (0.9% by mole) and hexafluoropropene (2.4% by mole) and having an intrinsic viscosity of 0.30 L/g in dimethylformamide at 25° C. This polymer is referred to hereinbelow as “Polymer 1”. The latter is incorporated with the other ingredients intended for the manufacture of the electrodes in the form of an acetone solution in which 10% of polymer 1 has been dissolved at 60° C. This solution is cooled down to room temperature and introduced into a glove box under an argon atmosphere (O₂<2 ppm, H₂O<2 ppm).

More specifically, active material, the preparation of which is explained in paragraph 1 hereinbelow, and C-Nergy® C65 carbon are added to the solution of anhydrous acetone at 99.9% purity comprising Polymer 1 and a liquid electrolyte composed of a mixture of carbonate solvents (ethylene carbonate/propylene carbonate 1/1) and LiPF₆(1M), so as to obtain a mass ratio (m_{electrolyte}/(m_{electrolyte}+m_{polymer 1}))*100 equal to 85.7%, whereby the resulting ink ultimately comprises 65% active material, 15% C-Nergy® C65 carbon and 20% Polymer 1.

The ink is deposited by coating over an aluminium substrate (more specifically, an aluminium foil with a 20 μm thickness).

As many gelled electrodes as necessary for making up the bipolar battery are prepared in accordance with this protocol.

Moreover, gelled electrodes prepared in accordance with this protocol have been tested in a button cell with, as a separator, a separator comprising the superposition of a sheet of Viledon® and a sheet of Celgard®, the separator being soaked in a liquid electrolyte comprising a mixture of carbonate solvents (ethylene carbonate/propylene carbonate, 1/1) and LiPF₆(1M).

The button cell thus obtained is subjected to a high-voltage galvanostatic test covering voltages ranging from 2.5 to 4V vs Li⁺/Li at a constant current corresponding to a C/10 regime, the active material of the gelled electrode undergoing in this context an oxidation of the lithium enolate groups into carbonyl groups (or in other words, undergoing delithiation), this oxidation or delithiation may be schematised by the following equation:

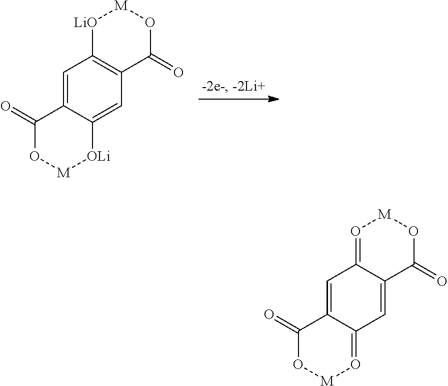

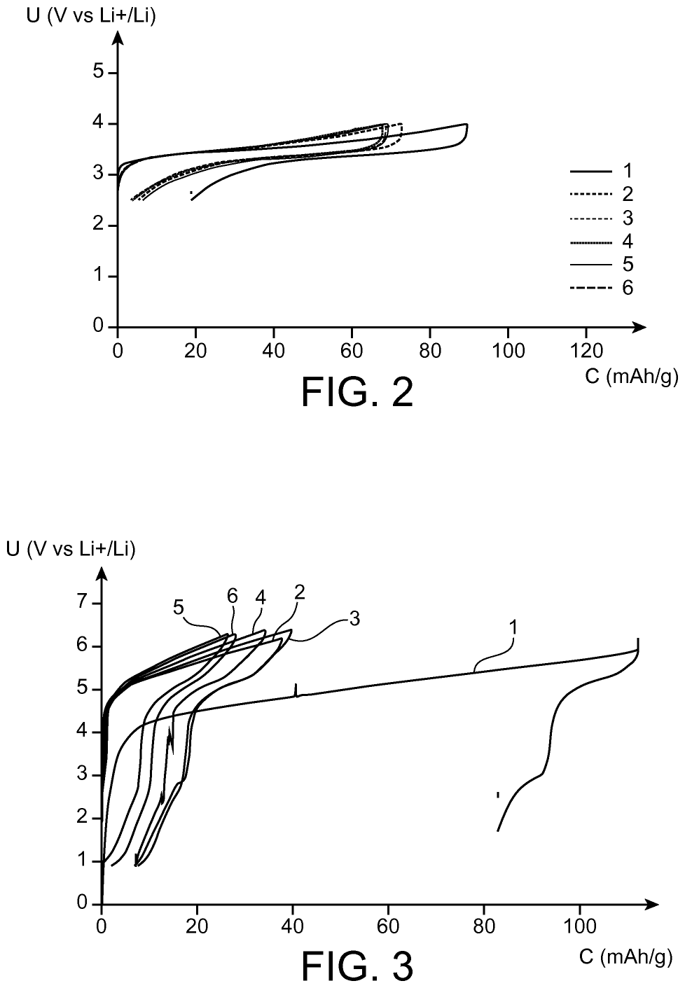

the results of this test being reported in FIG. 2 illustrating the evolution of the voltage U0 (in V vs Li⁺/Li) as a function of the specific capacitance C (in mAh·g⁻¹) for 6 consecutive cycles (respectively curve 1 for cycle 1, curve 2 for cycle 2, curve 3 for cycle 3, curve 4 for cycle 4, curve 5 for cycle 5 and curve 6 for cycle 6).

Starting from cycle 2, the curves are superimposed, which demonstrates the stability of the gelled electrodes and, what is more, the shape of the curves also demonstrates the ability of the gelled electrodes to behave, starting from the same active material, as an electrode capable of donating electrons.

3—Preparation of the Gelled Membrane

The gelled membrane consists of an organic/inorganic hybrid copolymer based on modified PVdF-HFP including methacrylic branches (PVdF-HEA-HFP) in which a sol-gel reaction is performed from tetraethoxysilane (TEOS).

It is obtained by coating a polymeric solution over a polyethylene terephthalate (PET) substrate then peeled off this substrate because it is self-supporting.

Preparation of the Polymeric Solution

To do so, 10 g of a copolymer comprising repeating units resulting from the polymerisation of vinylidene fluoride (VDF), 2-hydroxyethyl acrylate (HEA) and hexafluoropropene (HFP), this polymer being called PVdF-HEA-HFP (VDF 96.8% by mole-HEA 0.8% by mole and HFP 2.4% by mole) and having an intrinsic viscosity of 0.08 g/L are introduced into a 300 mL double-walled synthesis reactor inerted beforehand with argon and then 67 mL of anhydrous acetone at 99.9% purity are added. The mixture is mechanically stirred for 30 min at 60° C. under a flow of argon. Afterwards, 0.10 g of dibutyltin dilaurate (DBTL) are added and the resulting mixture is stirred for 90 minutes at 60° C. under a stream of argon. Afterwards, 0.40 g of 3-(triethoxysilyl)propyl isocyanate (TSPI) are added and the mixture is stirred for 90 minutes at 60° C. under a stream of argon. 37.50 g of electrolyte with composition identical to that used for the electrodes is added and the mixture is stirred for 30 min at 60° C. under a stream of argon. Afterwards, 2.50 g of formic acid are added and the mixture is stirred for 30 minutes at 60° C. under a stream of argon. Finally, 3.47 g of tetraethoxysilane are added and the mixture is stirred for 30 minutes at 60° C. under a stream of argon.

b) Preparation of the Membranes from the Polymeric Solution

Once prepared, the polymeric solution is transferred to a tight vial in an anhydrous room (dew point −20° C. to 22° C.). It is then coated using an R2R (“Roll to roll slot die coating machine, Ingecal tailored made”) coating machine, the solution being introduced into the machine at room temperature but in a controlled environment with a dew point of −20° C. to 22° C. The use settings of the machine are as follows:
Line speed: 1 m/min;
Drying section: 40° C. for the first and second areas; 50° C. for the third area and 60° C. for the fourth area;
Opening of the slot in extrusion: 300 μm, which allows obtaining a membrane of about 50 μm deposited over a polyethylene terephthalate (PET) substrate.

The membrane strip thus obtained is then stored in a heat-sealed tight bag while waiting to proceed with the assembly of the bipolar battery.

4—Preparation of the Bipolar Battery

Two electrodes prepared in accordance with the protocol of paragraph 2 are joined via their current collector substrate to form a two-face electrode comprising a bipolar current collector substrate resulting from the joining of the two current collector substrates and, on one face of the bipolar current collector substrate, an electrode and on the opposite face of the bipolar current collector substrate, another electrode.

Two membranes with the dimensions 34 mm×34 mm are cut from the membrane strip prepared beforehand and deposited over the 2 faces of the bipolar current collector coated with the electrodes. Two electrodes prepared in accordance with the protocol of paragraph 2 are then placed against the membranes, opposite each electrode with an opposite polarity of the bipolar current collector, these two electrodes making up the terminal electrodes. The two-compartment bipolar electrochemical core is then secured in a flexible package.

The bipolar battery thus obtained is subjected to a galvanostatic test covering voltages ranging from 1 to 6 V vs Li⁺/Li at a constant current corresponding to a C/10 regime, the results of this test being reported in FIG. 3 illustrating the evolution of the potential U (in V vs Li⁺/Li) as a function of the specific capacitance C (in mAh·g⁻¹) for 6 consecutive cycles (respectively, curve 1 for cycle 1, curve 2 for cycle 2, curve 3 for cycle 3, curve 4 for cycle 4, curve 5 for cycle 5 and curve 6 for cycle 6).

Starting from cycle 2, the curves are similar, which demonstrates the stability of the gelled electrodes and, what is more, the shape of the curves demonstrates the ability of the gelled electrodes to behave, starting from the same active material, both as a positive electrode and as a negative electrode.

What is claimed is:

1.-13. (canceled)

14. A battery with a bipolar architecture which comprises two terminal current collectors between which a stack of n electrochemical cells is disposed, n being an integer at least equal to 2, wherein:
each electrochemical cell comprises a positive electrode, a negative electrode and an electrolytic constituent disposed between the positive electrode and the negative electrode;
the n electrochemical cells are separated from each other by (n−1) bipolar current collectors;
and wherein the positive electrode and the negative electrode of each electrochemical cell comprise, as an active material, a common active material, which is an organic redox compound comprising, respectively, at least one group capable of capturing electrons and at least one group capable of donating electrons.

15. The battery according to claim 14, wherein the redox compound is a redox compound, in which the group(s) capable of capturing electrons is/are:
conjugated carbonyl groups;
carboxylate groups;
disulphide groups;
azo groups;
imide groups; or
heteroatomic groups;
and/or in which the group(s) capable of donating electrons are:
enol or enolate groups;
nitroxide groups;
thioether groups; or
aromatic amine groups.

16. The battery according to claim 14, wherein the redox compound is a compound comprising both at least one group selected from among conjugated carbonyl groups, carboxylate groups, disulphide groups and at least one group selected from among enol or enolate groups, nitroxide groups and thioether groups.

17. The battery according to claim 14, wherein the redox compound is a quinone compound substituted by at least one substituent comprising at least one group capable of donating electrons.

18. The battery according to claim 14, wherein the redox compound is a quinone compound selected from among benzoquinone compounds, naphthoquinone compounds and anthraquinone compounds, these compounds comprising at least one substituent comprising at least one group capable of donating electrons.

19. The battery according to claim 14, wherein the redox compound is a quinone compound in the enolate form, substituted by at least one group capable of capturing electrons.

20. The battery according to claim 19, wherein the redox compound is a benzoquinone compound in the enolate form substituted by at least one carboxylate group.

21. The battery according to claim 20, wherein the redox compound is a compound of the following formula (VIII): 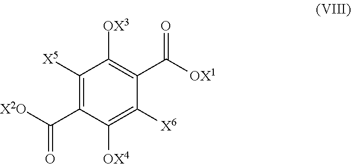
wherein X¹ to X⁴ represent, independently of each other, a cation and X⁵ and X⁶ represent, independently of each other, a hydrogen atom or a —SO₃H group.

22. The battery according to claim 14, wherein the negative electrodes and the positive electrodes of the battery further comprise electronic conductive additives.

23. The battery according to claim 14, wherein the negative electrodes and the positive electrodes are gelled electrodes.

24. The battery according to claim 23, wherein the gelled electrodes comprise a composite material comprising a polymeric matrix of at least one gelling polymer (FF) in contact with a liquid electrolyte, the electrode active material, the liquid electrolyte being confined within the polymeric matrix.

25. The battery according to claim 14, wherein the electrolytic constituent is a liquid electrolyte confined within a gelled polymer membrane.

26. The battery according to claim 25, wherein the gelled polymer membrane comprises an organic portion comprising at least one fluorinated polymer (F) comprising at least one repeating unit resulting from the polymerisation of a fluorinated monomer and at least one repeating unit resulting from the polymerisation of a monomer comprising at least one hydroxyl group and comprising an inorganic portion formed, entirely or partly, of one or more oxide(s) of at least one element M selected from among Si, Ti and Zr and combinations thereof.
